(19) United States
(12) Patent Application Publication
(10) Pub. No.: US 2013/0054730 A1
(43) Pub. Date: Feb. 28, 2013

(54) PORT CIRCUIT FOR HARD DISK BACKPLANE AND SERVER SYSTEM

(71) Applicants: Kang WU, Shenzhen City (CN); Bo TIAN, Shenzhen City (CN)

(72) Inventors: Kang WU, Shenzhen City (CN); Bo TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/523,877

(22) Filed: Jun. 14, 2012

(30) Foreign Application Priority Data
Aug. 25, 2011 (CN) 201110245671.0

(51) Int. Cl. G06F 15/167

(52) U.S. Cl. 709/213

(57) ABSTRACT

A port circuit for a hard disk backplane of a server system includes a control microchip and at least one selecting microchip. The hard disk backplane includes a number of ports. The server system includes a number of servers connected to a portion of the ports. The at least one selecting microchip is connected to the control microchip and other portion of ports of a hard disk backplane. When the control microchip detects that one or more standby servers form part of the server system, the control microchip selects the one or more standby server to connect to the other portion of the ports. When the control microchip does not detect that the one or more standby servers form part of the server system, the control microchip selects the servers to connect to the other portion of the ports.

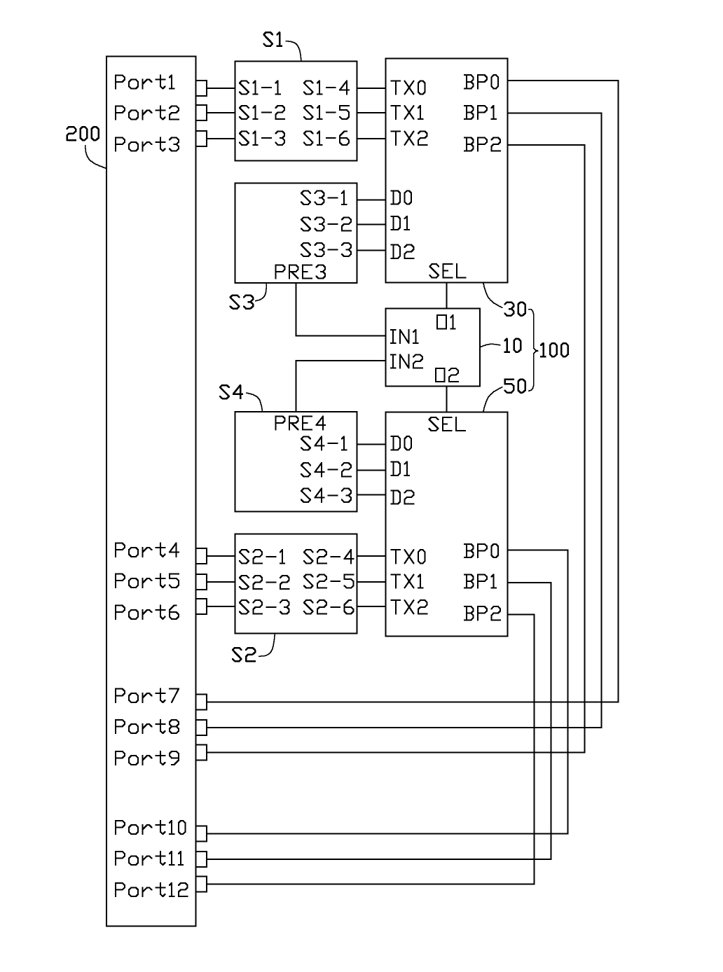

### BACKGROUND

1. Technical Field

The disclosure generally relates to hardware circuits for computers, and particularly to a port circuit for a hard disk backplane and a server system using the port circuit.

2. Description of Related Art

A 4-in-1 2U server system includes four servers sharing a hard disk backplane. Commonly, each server can provide six groups of serial advanced technology attachment (SATA) signals to the hard disk backplane to support hard disks installed on the hard disk backplane, and each hard disk backplane usually includes twelve ports configured for inserting twelve hard disks. Therefore, to control the twelve hard disks, each server outputs three groups of SATA signals to control three hard disks of the total twelve hard disks.

However, when the 2U server system needs to electronically connect to another server system, such as a server system that includes two servers, if each server maintains to control three hard disks, the 2U server system can only support six hard disks and only six hard disks can be used although the 2U server actually can provide twelve groups of SATA signals, which is an inefficient use of hardware.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

The FIGURE is a circuit diagram of a port circuit for hard disk backplane for a server system, according to an exemplary embodiment of the disclosure.

### DETAILED DESCRIPTION

The FIGURE is a circuit diagram of a port circuit 100 for hard disk backplane 200 for a server system, according to an exemplary embodiment of the disclosure. The server system may be a 2U or 3U server system, in this embodiment, the port circuit 100 is applied to the 2U server system as an example. The 2U server system includes two servers S1, S2 and two standby servers S3, S4. The two servers S1, S2 form part of the 2U server system, and the two standby servers S3, S4 can selectively form part of the 2U server system. The term “form part” means that the servers are electronically connected in the appropriate connection for a 2U or a 3U server configuration.

The port circuit 100 is installed on the hard disk backplane 200. The hard disk backplane 200 includes twelve ports Port1-Port12 configured for inserting hard disks. The port circuit 100 includes a control microchip 10 and two selecting microchips 30, 50.

The server S1 includes a group of SATA signal output terminals S1-1, S1-2, S1-3, S1-4, S1-5, and S1-6. The SATA signal output terminals S1-1, S1-2, and S1-3 are respectively connected to the ports Port1-Port3 of the hard disk backplane 200 and respectively output SATA signals S11, S12 and S13 to the ports Port1-Port2. The SATA signal output terminals S1-4 S1-5 and S1-6 are electrically connected to the selecting microchip 30 and respectively output SATA signal S14, S15, and S16 to the selecting microchip 30.

The structure of the server S2 is substantially similar to the server S1 and includes a group of SATA signal output terminals S2-1, S2-2, S2-3, S2-4, S2-5 and S2-6. The SATA signal output terminals S2-1, S2-2, and S2-3 are respectively connected to the ports Port4-Port6 of the hard disk backplane 200 and respectively output SATA signals S21, S22 and S23 to the ports Port4-Port6 of the hard disk backplane 200. The SATA signal output terminals S2-4, S2-5 and S2-6 are electrically connected to the selecting microchip 50 and respectively output SATA signal S24, S25, and S26 to the selecting microchip 50.

The standby server S3 includes a group of SATA signal output terminals S3-1, S3-2, S3-3 and a triggering terminal PRE3. When the standby server S3 forms part of the 2U server system, the SATA signal output terminals S3-1, S3-2, and S3-3 are electrically connected to the selecting microchip 30 and respectively output SATA signals S31, S32 and S33 to the selecting microchip 30, and the triggering terminal PRE3 is electrically connected to the control microchip 10 through a hard disk bridging plate (not shown) and sends a triggering signal which denotes the standby server S3 has already formed part of the 2U sever system to the control microchip 10.

The structure of the standby server S4 is substantially similar to the standby server S3 and includes a group of SATA signal output terminals S4-1, S4-2, S4-3 and a triggering terminal PRE4. When the standby server S4 forms part of the 2U server system, The SATA signal output terminals S4-1, S4-2, and S4-3 are electrically connected to the selecting microchip 50 and respectively output SATA signals S51, S52, and S53 to the selecting microchip 50, and the triggering terminal PRE4 is electrically connected to the control microchip 10 through a hard disk bridging plate (not shown) and sends the triggering signal which denotes the standby server S4 has already formed part of the 2U sever system to the control microchip 10.

The control microchip 10 includes two detecting terminals IN1, IN2 and two output terminals O1, O2. The two detecting terminals Ni, IN2 are respectively connected to the triggering terminal PRE3, PRE4 to receive the triggering signals. The two output terminals O1, O2 are respectively connected to the selecting microchips 30, 50.

When the detecting terminal IN1 receives the triggering signal from the standby server S3, which means the standby server S3 has already formed part of the 2U server system, the output terminal O1 outputs a first control signal, which may be a high level signal (i.e. logic 1) to the selecting microchip 30. Otherwise, the detecting terminal Ni does not receive the triggering signal, that is the standby server S3 is not installed to the 2U server system, the output terminal O1 outputs a second control signal, which may be a low level signal (i.e. logic 0) to the selecting microchip 30.

Similarly, when the detecting terminal IN2 receives the triggering signal from the standby server S4, which means the standby server S4 has already formed part of the 2U server system, the output terminal O2 outputs the first control signal, which may be a high level signal (i.e. logic 1) to the selecting microchip 30. Otherwise, the detecting terminal IN2 does not receive the triggering signal, which means the standby server S4 does not form part of the 2U server system, the output terminal O2 outputs a second control signal, which may be a low level signal (i.e. logic 0) to the selecting microchip 30.

The selecting microchip 30 includes three data receiving terminals TX0, TX1, and TX2, three data input terminals D0, D1, and D2, three data output terminals BPO, BP1, and BP2, and a selecting terminal SEL.

The data receiving terminal TX0, TX1, and TX2 are respectively connected to the SATA signal output terminals S1-4, S1-5, and S1-6 and receive the SATA signals S14, S15, and S16. The three data input terminals D0, D1, and D2 are connected to the SATA signal output terminals S3-1, S3-2, and S3-3 and receive the SATA signals S31, S33, and S33. The data output terminals BP0, BP1, and BP2 are respectively connected to the ports Port7-Port9. The selecting terminal SEL is electrically connected to the output terminal O1.

When the selecting terminal SEL receives the first control signal, the data input terminals D0, D1, and D2 are selected and switched to be connected to the data output terminals BP0, BP1, and BP2. The SATA signals S31, S32, and S33 from the standby severs S3 can be transmitted to the ports Port7-Port9. When the selecting terminal SEL receives the second control signal, the data receiving terminals TX0, TX1, TX3 are selected and switched to connect to the data output terminals BP0, BP1, and BP3, and the SATA signals S14, S15, and S16 from the severs S1 are transmitted to the ports Port7-Port9.

The structure of the selecting microchip 50 is substantially similar to the selecting microchip 30 and includes three data receiving terminals TX0, TX1, and TX3, three data input terminals D0, D1, and D2, three data output terminals BP0, BP1 and BP2 and a selecting terminal SEL. The differences are the data receiving terminals TX0, TX1, and TX3 of the selecting microchip 50 are connected to the SATA signal output terminals S2-4, S2-5, and S2-6; the three data input terminals D0, D1, and D2 are connected to the SATA signal output terminals S4-1, S4-2, and S4-3; the data output terminals BP0, BP1, and BP2 are respectively connected to the ports Port10-Port12; and the selecting terminal SEL is electrically connected to the output terminal O1.

In use, the two servers S1, S2 form part of the 2U server system. The ports Port1-Port3 receive the SATA signals S11, S12, S13 from the server S1, and the ports Port4-Port6 receive the SATA signals 521, S22, S23 from the server S2.

When the standby server S3 forms part of the 2U server system, the triggering terminal PRE3 outputs the triggering signal to the detecting terminal IN1, and the output terminal O1 outputs the first control signal to the selecting terminal SEL. The data input terminals D0, D1, and D2 are switched to connect to the data output terminals BP0, BP1, and BP2 and the SATA signals S31, S32, and S33 from the standby severs S3 can be transmitted to the ports Port7-Port9.

When the selecting terminal SEL receives the second control signal, the data receiving terminals TX0, TX1, TX3 are switched to connect to the data output terminals BP0, BP1, and BP3, and the SATA signals S14, S15, and S16 from the severs S1 are transmitted to the ports Port7-Port9. Therefore, no matter if the standby server S3 forms part of the 2U server system or not, the port Port7-Port9 can be used.

The operation principle of the selecting microchip 50 is substantially similar to the selecting microchip 30, thus detail description of the selecting microchip 50 is omitted. Similarly, no matter if the standby server S4 forms part of the 2U server system or not, the port Port10-Port12 can be used.

In other embodiments, if only one of the standby servers S3, S4 selectively forms part of the 2U server system, one of the selecting microchips 30, 50 can be correspondingly omitted.

In other embodiments, if the port circuit of hard disk backplane 100 is applied to a 3U server system, the number of the standby servers and the number of the selecting microchips can be correspondingly increased.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A port circuit for a hard disk backplane of a server system, the hard disk backplane comprising a plurality of ports, the server system comprising a plurality of servers connected to a first group of the ports, the port circuit comprising:
a control microchip configured for detecting whether one or more standby servers electronically form part of the server system, the control microchip comprising at least one detecting terminal electrically connected to the one or more standby servers when the one or more standby servers form part of the server system; and
at least one selecting microchip connected to the control microchip and a second group of the hard disk backplane, wherein when the control microchip detects one or more standby servers that form part of the server system, the control microchip selects the one or more standby servers to connect to the second group of the ports via the least one selecting microchip; and
when the control microchip does not detects the one or more standby servers form part of the server system, the control microchip selects the servers to connect to the second group of the ports via the least one selecting microchip.

2. The port circuit of claim 1, wherein the at least one selecting microchip comprises a plurality of data receiving terminals connected to one of the servers, a plurality of data input terminals connected to the one or more standby servers, a plurality of data output terminals corresponding to the data receiving terminals and the data input terminals connected to the second group of the ports and a selecting terminal connected to the control microchip, the control microchip controls the selecting terminal to select the data receiving terminals or the data input terminals to connect to the data output terminals.

3. The port circuit of claim 2, wherein the control microchip further comprises at least one output terminal connected to the selecting terminals, when the one or more standby servers form part of the server system, the at least one detecting terminal receive a triggering signal from the one or more standby servers, and the at least one output terminal output a first control signals to the selecting terminals.

4. The port circuit of claim 3, wherein when the one or more standby servers do not form part of the server system, the at least one detecting terminal do not receive the triggering signal, and the at least one output terminal output a second control signals to the selecting terminals.

5. A server system, comprising:
a hard disk backplane comprising a plurality of ports;
a plurality of servers form part of the server system and connected to a first group of the ports;
one or more standby servers selectively form part of the server system;
a port circuit, comprising:
a control microchip configured for detecting whether one or more standby servers form part of the server system, the control microchip comprising at least one detecting terminal electrically connected to the one or more standby servers when the one or more standby servers form part of the server system; and
at least one selecting microchip connected to the control microchip and a second group of the ports; wherein when the control microchip detects one or more standby servers form part of the server system, the control microchip selects the one or more standby servers to connect to the second group of the ports via the least one selecting microchip;
when the control microchip does not detect the one or more standby servers form part of the server system, the control microchip selects the servers to connect to the second group of the ports via the least one selecting microchip.

6. The server system of claim 5, wherein the at least one selecting microchip comprises a plurality of data receiving terminals connected to one of the servers, a plurality of data input terminals connected to the one or more standby servers, a plurality of data output terminals corresponding to the data receiving terminals and the data input terminals connected to the second group of the ports and a selecting terminal connected to the control microchip, the control microchip controls the selecting terminal to select the data receiving terminals or the data input terminals to connect to the data output terminals.

7. The server system of claim 6, wherein the control microchip further comprises at least one output terminal connected to the selecting terminals, when the one or more standby servers form part of the server system, the at least one detecting terminal receive a triggering signal from the one or more standby servers, and the at least one output terminal output a first control signals to the selecting terminals.

8. The server system of claim 7, wherein when the one or more standby servers do not form part of the server system, the at least one detecting terminal do not receive the triggering signal, and the at least one output terminal output a second control signals to the selecting terminals.

9. The server system of claim 6, wherein each server comprises a group of signal output terminals, a first group of the signal output terminals are electrically connected to the ports, a second group of the signal output terminals are electrically connected to the data receiving terminals.

10. The server system of claim 7, wherein the one or more standby servers comprise a group of the signal output terminals and a triggering terminal, when the one or more standby servers form part of the server system, the signal output terminals are electrically connected to the selecting microchip and the triggering terminal is electrically connected to the control microchip and sends the triggering signal.
